(19) United States
(12) Patent Application Publication
(10) Pub. No.: US 2025/0201472 A1
(43) Pub. Date: Jun. 19, 2025

(54) INJECTION-MOLDED FIXTURE-INTEGRATED TRANSFORMER AND TRANSFORMER MODULE THEREOF

(71) Applicant: Atum Co., Ltd., Ansan-si (KR)

(72) Inventor: Taeksoo HAN, Seoul (KR)

(21) Appl. No.: 18/974,345

(22) Filed: Dec. 9, 2024

(30) Foreign Application Priority Data
Dec. 19, 2023 (KR) 10-2023-0186460

(51) Int. Cl. H01F 27/33; H01F 27/02; H01F 27/24; H01F 27/32

(52) U.S. Cl. CPC H01F 27/33; H01F 27/022; H01F 27/025; H01F 27/24; H01F 27/324

(57) ABSTRACT

Provided relates to an injection-molded fixture-integrated transformer and an injection-molded fixture-integrated transformer module thereof. The injection-molded fixture-integrated transformer includes: winding-type insulated coils (110, 120), on which flexible insulated wires are wound multiple times around hollow parts (110a, 120a), which are formed at the center thereof for the insertion of middle parts of magnetic cores (130, 140, 310, 320), with the turns in close contact with each other; and injection-molded fixtures (112, 122, 212, 222), which wrap the winding-type insulated coils (110, 120) by synthetic resin injection-molding, are formed integrally with the winding-type insulated coils (110, 120), and electrically insulate the winding-type insulated coils (110, 120) from the outside to maintain the fixed form of the insulated wire which is wound multiple times and forms the winding-type insulated coils (110, 120), thereby reducing the size of the transformer, simplifying the manufacturing process, and being resistant to vibrations and shocks.

### BACKGROUND OF THE INVENTION

### Field of the Invention

The present invention relates to a transformer and a transformer module.

### Background Art

In general, a transformer includes a bobbin made of synthetic resin and a winding coil formed by winding a conductive wire around the bobbin.

In the conventional transformer, the bobbin serves as a member for winding the coil and serves as a member for maintaining the shape of the winding coil.

However, since adopting the bobbin to secure the winding coil, the conventional transformer has several disadvantages in that the overall volume of the transformer is increased and man hour and manufacturing time are also increased.

Furthermore, the conventional transformer adopting the bobbin has another disadvantage is vulnerable to vibration and impact.

### SUMMARY OF THE INVENTION

Accordingly, the present invention has been made to solve the above-mentioned problems occurring in the prior arts.

It is a first objective of the present invention to provide an injection-molded fixture-integrated transformer and a transformer module thereof, which can reduce the occupied space of the transformer and lower the height (profile) of the transformer by adopting an injection-molded fixture instead of the bobbin which the conventional arts adopted, thereby reducing the overall occupied space of a main PCB board (e.g., OBC or LDC in an electric vehicle) on which the transformer is mounted, and lowering the height (profile) of the main PCB board.

It is a second objective of the present invention to provide an injection-molded fixture-integrated transformer and a transformer module thereof, which can improve assembly efficiency of the transformer and reduce the assembly processes by adopting an injection-molded fixture instead of the bobbin which the conventional arts adopted and integrally bonding the injection-molded fixture to the transformer coil (including a resonant inductor coil) through insert molding, thereby enhancing productivity.

It is a third objective of the present invention to provide an injection-molded fixture-integrated transformer and a transformer module thereof, which adopt an injection-molded fixture instead of the bobbin, which the conventional arts adopted, and integrally bonds the injection-molded fixture to the transformer coil through insert molding so that the injection-molded fixture can securely hold the coils (including a resonant inductor coil) of the transformer without clearance or movement and can firmly hold the coils of the transformer even in environments where significant vibration or impact is applied to the main PCB board, such as the OBC or LDC of an electric vehicle.

It is a fourth objective of the present invention to provide an injection-molded fixture-integrated transformer and a transformer module thereof, which can improve heat dissipation efficiency and enhancing insulation effect by filling spaces between turns of the wire of the transformer coil (including resonant inductor coils) with injection-molding resin during the insert molding process of the transformer coil.

To accomplish the above object, according to the present invention, there is provided an injection-molded fixture-integrated transformer including: a first injection-molded fixture-integrated coil unit, which includes: a first winding-type insulated coil, on which a flexible insulated wire is wound multiple times around a first hollow part, which is formed at the center thereof for the insertion of middle parts of magnetic cores, with the turns in close contact with each other; and a first injection-molded fixture, which wraps the first winding-type insulated coil by synthetic resin injection-molding, is formed integrally with the first winding-type insulated coil, and electrically insulates the first winding-type insulated coil from the outside to maintain the fixed form of the insulated wire which is wound multiple times and forms the first winding-type insulated coil; and a second injection-molded fixture-integrated coil unit, which includes: a second winding-type insulated coil, which generates induced current from the current applied to the first winding-type insulated coil, and on which a flexible insulated wire is wound multiple times around a second hollow part, which is formed at the center thereof for the insertion of the middle parts of the magnetic cores, with the turns in close contact with each other; and a second injection-molded fixture, which wraps the second winding-type insulated coil by synthetic resin injection-molding, is formed integrally with the second winding-type insulated coil and electrically insulates the second winding-type insulated coil from the outside to maintain the fixed form of the insulated wire which is wound multiple times and forms the second winding-type insulated coil.

In another aspect of the present invention, there is provided an injection-molded fixture-integrated transformer module including: the injection-molded fixture-integrated transformer; a first injection-molded fixture-integrated resonant coil unit, which includes: a first resonant inductor coil, which is directly connected to the first winding-type insulated coil to perform the resonant interaction with the inherent capacitance of the transformer, and on which a flexible insulated wire is wound multiple times around a third hollow part, which is formed at the center thereof for the insertion of a middle part of a magnetic core, with the turns in close contact with each other; and a third injection-molded fixture, which wraps the first resonant inductor coil by synthetic resin injection-molding, is formed integrally with the first resonant inductor coil, and electrically insulates the first resonant inductor coil from the outside to maintain the overall specific form of the insulated wire which is wound multiple times and forms the first winding-type insulated coil; and a second injection-molded fixture-integrated resonant coil unit, which includes: a second resonant inductor coil, which is directly connected to the second winding-type insulated coil to perform the resonant interaction with the inherent capacitance of the transformer, and on which a flexible insulated wire is wound multiple times around a fourth hollow part, which is formed at the center thereof for the insertion of a middle part of a magnetic core, with the turns in close contact with each other; and a fourth injection-molded fixture, which wraps the second resonant inductor coil by synthetic resin injection-molding, is formed integrally with the second resonant inductor coil, and electrically insulates the second resonant inductor coil from the outside to maintain the overall specific form of the insulated wire which is wound multiple times and forms the second resonant inductor coil.

The injection-molded fixture-integrated transformer and the transformer module thereof, having the above-described configuration, provide the following effects.

First, the injection-molded fixture-integrated transformer and the transformer module thereof can reduce the occupied space of the transformer and lower the height (profile) of the transformer by adopting an injection-molded fixture instead of the bobbin which the conventional arts adopted, thereby reducing the overall occupied space of a main PCB board (e.g., OBC or LDC in an electric vehicle) on which the transformer is mounted, and lowering the height (profile) of the main PCB board.

Second, the injection-molded fixture-integrated transformer and the transformer module thereof can improve assembly efficiency of the transformer and reduce the assembly processes by adopting an injection-molded fixture instead of the bobbin which the conventional arts adopted and integrally bonding the injection-molded fixture to the transformer coil (including a resonant inductor coil) through insert molding, thereby enhancing productivity.

Third, the injection-molded fixture-integrated transformer and the transformer module thereof, by adopting an injection-molded fixture instead of the bobbin which the conventional arts adopted and integrally bonding the injection-molded fixture to the transformer coil through insert molding, can allow the injection-molded fixture to securely hold the coils (including a resonant inductor coil) of the transformer without clearance or movement and can firmly hold the coils of the transformer even in environments where significant vibration or impact is applied to the main PCB board, such as the OBC or LDC of an electric vehicle.

Fourth, the injection-molded fixture-integrated transformer and the transformer module thereof can improve heat dissipation efficiency and enhancing insulation effect by filling spaces between turns of the wire of the transformer coil (including resonant inductor coils) with injection-molding resin during the insert molding process of the transformer coil.

### BRIEF DESCRIPTION OF THE DRAWINGS

FIG. 1 is a perspective view of an injection-molded fixture-integrated transformer module 1 according to an embodiment of the present invention.

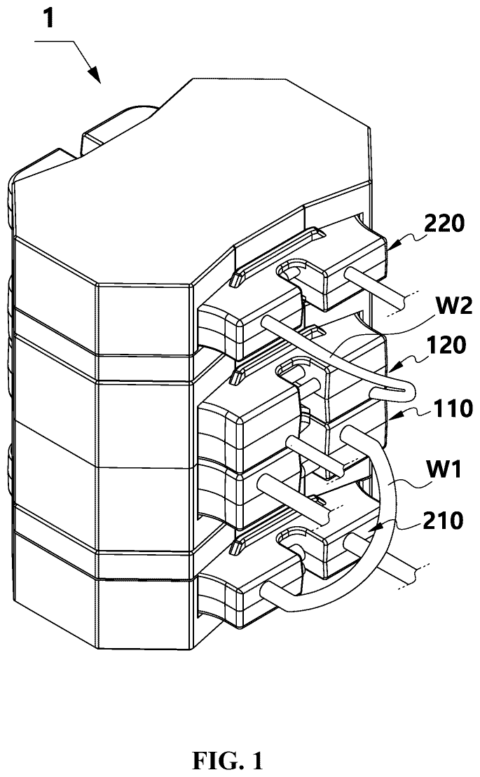

FIG. 2 is a side view of the injection-molded fixture-integrated transformer module 1 according to an embodiment of the present invention.

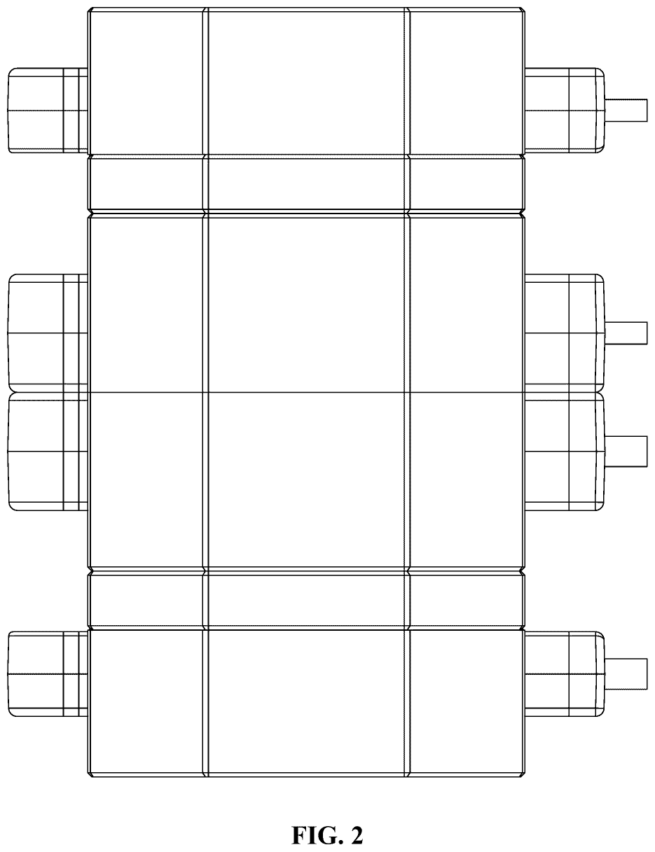

FIG. 3 is a conceptual diagram illustrating the front configuration of the injection-molded fixture-integrated transformer module 1 according to an embodiment of the present invention.

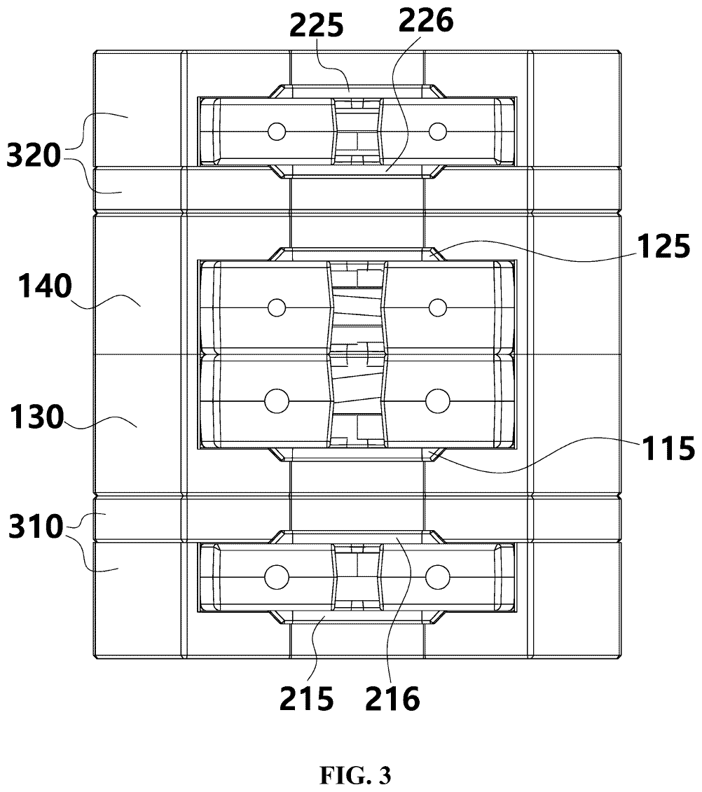

FIG. 4 is a cross-sectional view of FIG. 1 in the horizontal direction of FIG. 1.

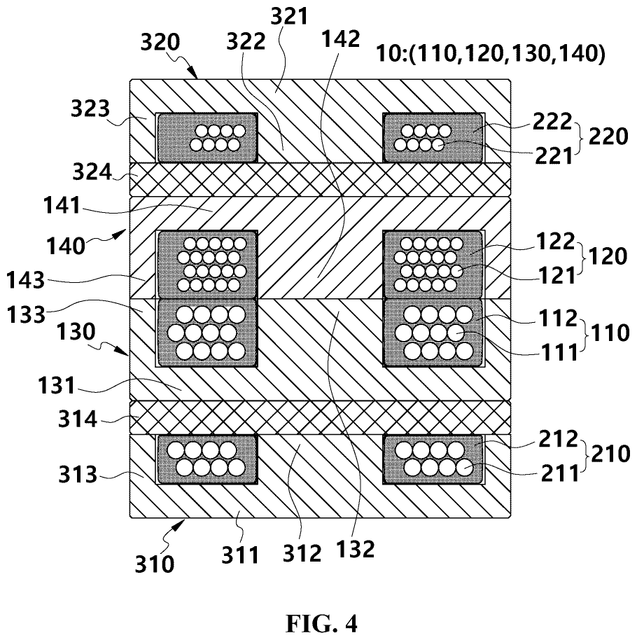

FIG. 5 is an exploded perspective view of the upper side of an essential part of the injection-molded fixture-integrated transformer module 1 according to an embodiment of the present invention.

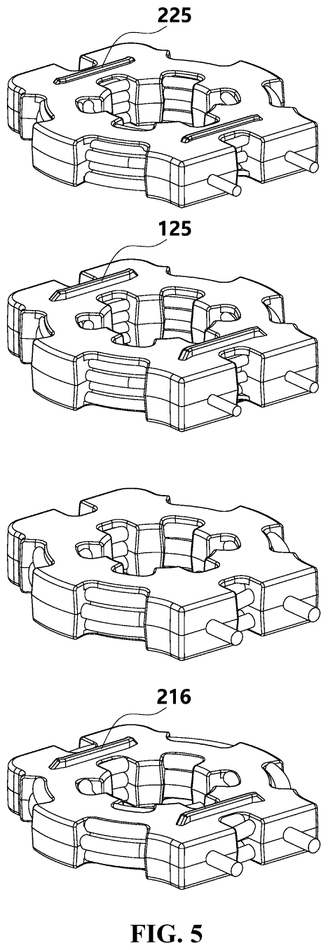

FIG. 6 is an exploded perspective view of the lower side of an essential part of the injection-molded fixture-integrated transformer module 1 according to an embodiment of the present invention.

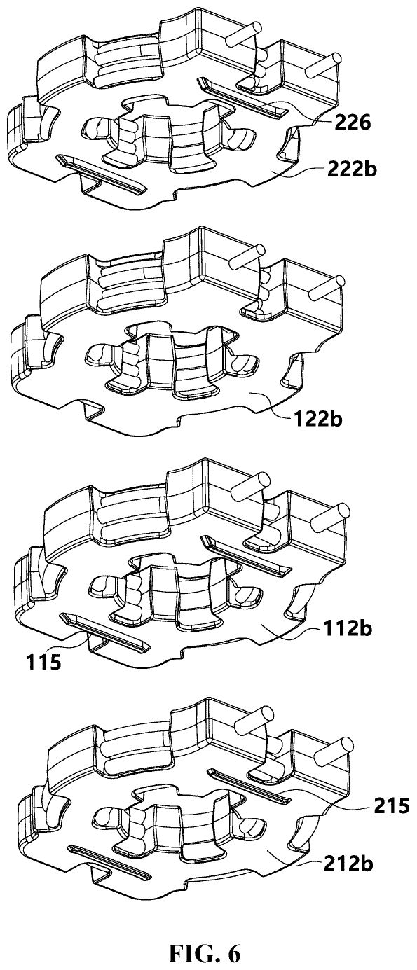

FIG. 7 is a plan view of coil units 110, 120, 210 and 220 in the injection-molded fixture-integrated transformer module 1 according to an embodiment of the present invention.

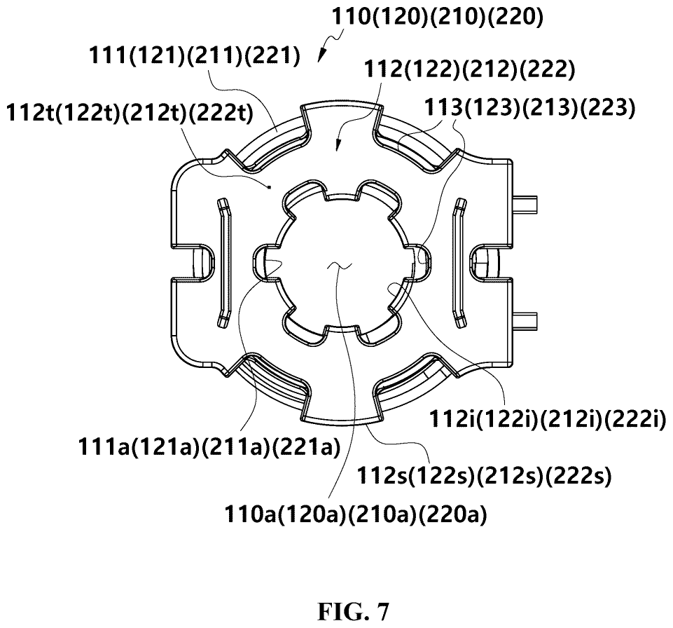

FIGS. 8A and 8B are a conceptual diagram of the operation, in which coils are inserted into a cavity of an injection mold to form the coil units 110, 120, 210 and 220, in the injection-molded fixture-integrated transformer module 1 according to an embodiment of the present invention, wherein FIG. 8A is a conceptual diagram showing the simultaneous molding of a first injection-molded fixture-integrated coil unit 110 and a first injection-molded fixture-integrated resonant coil unit 210 by inserting a first winding-type insulated coil 111 and a first resonant inductor coil 211 into cavities M1a and M1b of two injection molds, and FIG. 8B is a conceptual diagram showing the simultaneous molding of a second injection-molded fixture-integrated coil unit 120 and a second injection-molded fixture-integrated resonant coil unit 220 by inserting a second winding-type insulated coil 121 and a second resonant inductor coil 221 into cavities M2a and M2b of two injection molds

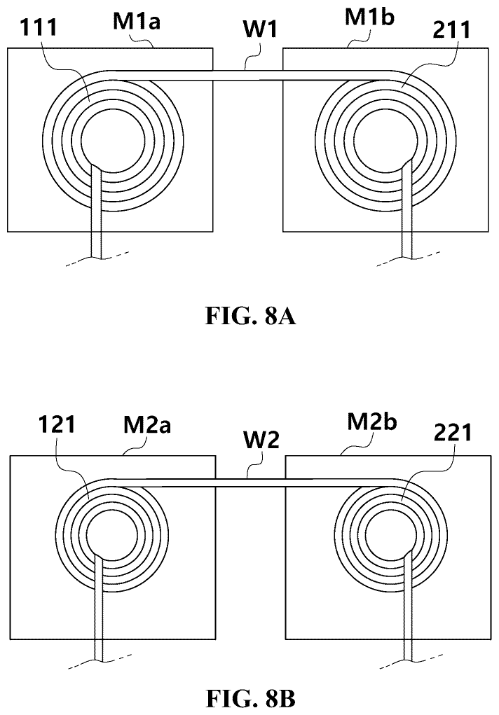

FIGS. 9A, 9B and 9C are an illustrative diagram showing insulated wires W1 and W2 forming the winding-type insulated wires used in the injection-molded fixture-integrated coil units 110, 120, 210, and 220, the injection-molded fixture-integrated transformer 10, and a transformer module 1, wherein FIG. 9A is a conceptual diagram of the outward appearance, FIG. 9B is a cross-sectional layer conceptual diagram, and FIG. 9C is a conceptual diagram showing the outward appearance to which a plurality of fine copper wires (Li) are exposed.

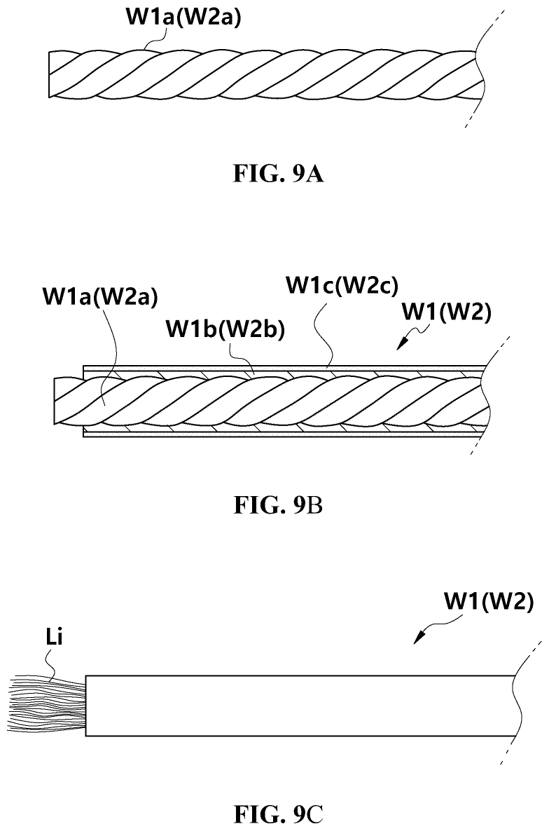

### DETAILED DESCRIPTION OF THE PREFERRED EMBODIMENT

With reference to the accompanying drawings, an injection-molded fixture-integrated transformer and a transformer module thereof according to the present invention will now be described in detail.

First, the configuration of an injection-molded fixture-integrated transformer 10 according to one embodiment of the present invention will be described.

According to an embodiment of the present invention, the injection-molded fixture-integrated transformer 10 includes a first injection-molded fixture-integrated coil unit 110 and a second injection-molded fixture-integrated coil unit 120.

The first injection-molded fixture-integrated coil unit 110 includes: a first winding-type insulated coil 111, on which a flexible insulated wire W1 is wound multiple times around a first hollow part 111a which is formed at the center thereof for the insertion of middle parts 132 and 142 of magnetic cores 130 and 140, with the turns in close contact with each other; and a first injection-molded fixture 112, which wraps the first winding-type insulated coil 111 by synthetic resin injection-molding, is formed integrally with the first winding-type insulated coil 111, and electrically insulates the first winding-type insulated coil 111 from the outside to maintain the fixed form of the insulated wire W1 which is wound multiple times and forms the first winding-type insulated coil 111.

Moreover, the second injection-molded fixture-integrated coil unit 120 includes: a second winding-type insulated coil 121, which generates induced current from the current applied to the first winding-type insulated coil 111, and on which a flexible insulated wire W2 is wound multiple times around a second hollow part 121a, which is formed at the center thereof for the insertion of the middle parts 132 and 142 of the magnetic cores 130 and 140, with the turns in close contact with each other; and a second injection-molded fixture 122, which wraps the second winding-type insulated coil 121 by synthetic resin injection-molding, is formed integrally with the second winding-type insulated coil 121 and electrically insulates the second winding-type insulated coil 121 from the outside to maintain the fixed form of the insulated wire which is wound multiple times and forms the second winding-type insulated coil 121.

According to the above configuration, the injection-molded fixture-integrated transformer 10 can reduce the occupied space of the transformer and lower the height (profile) of the transformer by adopting the first and second injection-molded fixtures 112 and 122 instead of the bobbin which the conventional arts adopted, thereby reducing the overall occupied space of a main PCB board (e.g., OBC or LDC in an electric vehicle) on which the transformer is mounted, and lowering the height (profile) of the main PCB board.

The first injection-molded fixture 112 is formed along the first winding-type insulated coil 111 to partially enclose (wrap) the first winding-type insulated coil 111, which is in the shape of a ring. The first injection-molded fixture 112 has a plurality of first exposure parts 113 formed to expose the first winding-type insulated coil 111.

The second injection-molded fixture 122 is formed along the second winding-type insulated coil 121 to partially enclose (wrap) the second winding-type insulated coil 121, which is in the shape of a ring. The second injection-molded fixture 122 has a plurality of second exposure parts 123 formed to expose the second winding-type insulated coil 121.

The first injection-molded fixture 112 which partially encloses (wraps) the first winding-type insulated coil 111 includes a first flat top surface 112t, a first flat bottom surface 112b, a first inner surface 112i with a hollow part 110a, and a first circumference 112s which is the exterior surface, and the plurality of first exposure parts 113 are formed along the first inner surface 112i and the first outer circumference 112s.

The second injection-molded fixture 122 which partially encloses (wraps) the second winding-type insulated coil 121 includes a second flat top surface 122t, a second flat bottom surface 122b, a second inner surface 122i with a hollow part 120a, and a second circumference 122s which is the exterior surface, and the plurality of second exposure parts 123 are formed along the second inner surface 122i and the second outer circumference 122s.

According to the above configuration, the injection-molded fixture-integrated transformer 10 can firmly fix the first winding-type insulated coil 111 and the second winding-type insulated coil 121 and improve heat dissipation efficiency.

Additionally, the injection-molded fixture-integrated transformer 10 can increase the magnetic coupling and efficiency between the first winding-type insulated coil 111 and the second winding-type insulated coil 121 to enhance the close contact with other components (the magnetic core 130 and 140 and the opposing winding-type insulated coils 111 and 112).

Here, the first and second top surfaces 112t and 122t, the first and second bottom surfaces 112b and 122b, the first and second inner surfaces 112i and 122i, and the first and second outer circumferences 112s and 122s of the first and second injection-molded fixtures 112 and 122 are substantially the same as the top surfaces, the bottom surfaces, the inner surfaces, and the circumferences 112s and 122s of the injection-molded fixture-integrated coil units 110 and 120.

Likewise, the hollow parts of the first and second injection-molded fixtures 112 and 122 are substantially the same as the hollow parts 110a and 120a of the injection-molded fixture-integrated coil units 110 and 120.

In the injection-molded fixture-integrated transformer 10 according to an embodiment of the present invention, the first winding-type insulated coil 111 is inserted into a cavity M1a of the injection mold in such a manner that a wire inlet side (not illustrated) and a wire outlet side (not illustrated) are exposed, a molding resin is injected under high pressure into the cavity of the injection mold to form the first injection-molded fixture 112 and integrally bond the first injection-molded fixture 112 with the first winding-type insulated coil 111, and then, injection resin fills between the turns of the first winding-type insulated coil 111 to form the first injection-molded fixture 112.

Likewise, the second winding-type insulated coil 121 is inserted into a cavity M2a of the injection mold in such a manner that a wire inlet side and a wire outlet side are exposed, a molding resin is injected under high pressure into the cavity of the injection mold to form the second injection-molded fixture 122 and integrally bond the second injection-molded fixture 122 with the second winding-type insulated coil 121, and then, injection resin fills between the turns of the second winding-type insulated coil 121 to form the second injection-molded fixture 122.

The insulated wire W1 forming the first winding-type insulated coil 111 is an insulated wire, and the first winding-type insulated coil 111 is a winding-type insulated coating coil. Likewise, the insulated wire W2 forming the second winding-type insulated coil 121 is an insulated wire, and the second winding-type insulated coil 121 is a winding-type insulated coil.

The first winding-type insulated coil 111 is a winding-type insulated coated coil having a conductive wire W1a covered with insulating tape W1b, and the second winding-type insulated coil 121 is a winding-type insulated coated coil having a conductive wire W2a covered with insulating tape W2b.

Furthermore, the first and second winding-type insulated coils 111 and 121 include adhesive-type insulated coated wires W1 and W2, which have bonding layers W1c and W2c formed by covering conductive wires W1a and W2a with insulating tapes W1b and W2b and coating the outer circumferential surfaces of the covered insulating tapes W1b and W2b with an adhesive. After winding the adhesive-type insulated coated wires W1 and W2 around a winding member (not illustrated) multiple times to form a hollow part at the center, the bonding layers W1c and W2c are melted by solvent, such as alcohol, or melted (fused) by applying heat (or hot air), and then, are hardened so that the closely wound adhesive-type insulated coated wires W1 and W2 are bonded by fusion to form a coil shape.

Accordingly, the injection-molded fixture-integrated transformer 10 can maintain the efficiency between the first coil and the second coil without causing the dielectric breakdown even under high voltages ranging from several to tens of kV.

Additionally, the injection-molded fixture-integrated transformer 10 can maintain the standardized form of the coil even when high-pressure injection resin is pressed during the insert injection.

The injection-molded fixture-integrated transformer 10 according to an embodiment of the present invention is a transformer for an on-board charger (OBC) of an electric vehicle.

Next, an injection-molded fixture-integrated transformer module 1 according to an embodiment of the present invention will be described.

The injection-molded fixture-integrated transformer module 1 includes the injection-molded fixture-integrated transformer 10, a first injection-molded fixture-integrated resonant coil unit 210, and a second injection-molded fixture-integrated resonant coil unit 220.

The first injection-molded fixture-integrated resonant coil unit 210, to perform the resonant interaction with the inherent capacitance Cp of the injection-molded fixture-integrated transformer 10, includes: a first resonant inductor coil 211, which is directly connected to the first winding-type insulated coil 111, and on which a flexible insulated wire W1 is wound multiple times around a third hollow part, which is formed at the center thereof for the insertion of a middle parts 312 of a magnetic core 310, with the turns in close contact with each other; and a third injection-molded fixture 212, which wraps the first resonant inductor coil 211 by synthetic resin injection-molding, is formed integrally with the first resonant inductor coil 211, and electrically insulates the first resonant inductor coil 211 from the outside to maintain the overall specific form of the insulated wire W1 which is wound multiple times and forms the first winding-type insulated coil 111.

The second injection-molded fixture-integrated resonant coil unit 220, to perform the resonant interaction with the inherent capacitance Cp of the injection-molded fixture-integrated transformer 10, includes: a second resonant inductor coil 221, which is directly connected to the second winding-type insulated coil 121, and on which a flexible insulated wire W2 is wound multiple times around a fourth hollow part, which is formed at the center thereof for the insertion of a middle parts 322 of a magnetic core 320, with the turns in close contact with each other; and a fourth injection-molded fixture 222, which wraps the second resonant inductor coil 221 by synthetic resin injection-molding, is formed integrally with the second resonant inductor coil 221, and electrically insulates the second resonant inductor coil 221 from the outside to maintain the overall specific form of the insulated wire W2 which is wound multiple times and forms the second resonant inductor coil 221.

By including the resonant inductor in the transformer, the injection-molded fixture-integrated transformer module can perform the resonant interaction with the inherent capacitance of the transformer.

In addition, since the first and second resonant inductor coils 211 and 221 are formed integrally with the transformer 10, the injection-molded fixture-integrated transformer module is reduced in occupied space, thus making the circuit design on the PCB more favorable, and reducing the number of components and the size of the PCB during integrated circuit design.

Moreover, since the first and second resonant inductor coils 211 and 221 are formed integrally with the transformer 10, the injection-molded fixture-integrated transformer module can reduce costs.

In the injection-molded fixture-integrated transformer module 1 according to an embodiment of the present invention, the first winding-type insulated coil 111 and the first resonant inductor coil 211 are formed by a single insulated wire W1. The first winding-type insulated coil 111 is inserted into a cavity M1a of an injection mold in a state where a wire inlet side and a wire outlet side of the first winding-type insulated coil 111 are exposed, and the first resonant inductor coil 211 is inserted into a cavity M1b of the injection mold in a state where a wire inlet side and a wire outlet side of the first resonant inductor coil 211 are exposed. When resin for forming first and third injection-molded fixtures 112 and 212 is injected into the cavities M1a and M1b of the injection mold under high pressure, the first injection-molded fixture 112 is formed, and at the same time, the first winding-type insulated coil 111 is integrally bonded with the first injection-molded fixture 112, and the third injection-molded fixture 212 is formed, and at the same time, the third resonant inductor coil 211 is integrally bonded with the third injection-molded fixture 212. The injection resin fills the spaces between the turns of the first winding-type insulated coil 111 for forming the first injection-molded fixture 112, and fills the spaces between the turns of the first resonant inductor coil 211 for forming the third injection-molded fixture 212.

In addition, the second winding-type insulated coil 121 and the second resonant inductor coil 221 are formed by a single insulated wire W2. The second winding-type insulated coil 121 is inserted into a cavity M2a of the injection mold in a state where a wire inlet side and a wire outlet side of second winding-type insulated coil 121 are exposed, and the second resonant inductor coil 221 is inserted into a cavity M2b of the injection mold in a state where a wire inlet side and a wire outlet side of second resonant inductor coil 221 are exposed. When resin for forming second and fourth injection-molded fixtures 122 and 222 is injected into the cavities M2a and M2b of the injection mold under high pressure, the second injection-molded fixture 122 is formed, and at the same time, the second winding-type insulated coil 121 is integrally bonded with the second injection-molded fixture 122, and the fourth injection-molded fixture 222 is formed, and at the same time, the second resonant inductor coil 221 is integrally bonded with the fourth injection-molded fixture 222. The injection resin fills the spaces between the turns of the second winding-type insulated coil 121 for forming the second injection-molded fixture 122, and fills the spaces between the turns of the second resonant inductor coil 221 for forming the fourth injection-molded fixture 222.

That the first winding-type insulated coil 111 and the first resonant inductor coil 211 are formed by a single insulated wire W1 means that the first winding-type insulated coil 111 is formed first from the single insulated wire W1 and the first resonant inductor coil 211 is subsequently formed (extended) from the already formed first winding-type insulated coil 111.

Likewise, that the second winding-type insulated coil 121 and the second resonant inductor coil 221 are formed by the single insulated wire W2 means that the second winding-type insulated coil 121 is formed first from the single insulated wire W2 and the second resonant inductor coil 221 is subsequently formed (extended) from the already formed second winding-type insulated coil 121.

The third injection-molded fixture 212 is formed along the first resonant inductor coil 211 with a ring shape to partially enclose (surround) the first resonant inductor coil 211, and includes a plurality of third exposure parts 213 for exposing the first resonant inductor coil 211.

Likewise, the fourth injection-molded fixture 222 is formed along the second resonant inductor coil 221 with a ring shape to partially enclose (surround) the second resonant inductor coil 221, and includes a plurality of fourth exposure parts 223 for exposing the second resonant inductor coil 221.

Furthermore, the third injection-molded fixture 212, which partially encloses the first resonant inductor coil 211, includes a flat top surface 212t, a flat bottom surface 212b, a third inner surface 212i with a hollow part 210a, and a third circumference 212s which is the exterior surface. The third exposure parts 213 are formed along the third inner surface 212i and the third circumference 212s.

Likewise, the fourth injection-molded fixture 222, which partially encloses the second resonant inductor coil 221, includes a flat top surface 222t, a flat bottom surface 222b, a fourth inner surface 222i with a hollow part 220a, and a fourth circumference 222s which is the exterior surface. The fourth exposure parts 224 are formed along the fourth inner surface 222i and the fourth circumference 222s.

According to the above configuration, the injection-molded fixture-integrated transformer module can securely fix the first and second resonant inductor coils 211 and 221 and enhance heat dissipation efficiency.

Here, the top surfaces 212t and 222t, the bottom surfaces 212b and 222b, the inner surfaces 212i and 222i, and the outer circumferences 212s and 222s of the third and fourth injection-molded fixtures 212 and 222 are substantially the same as the top surfaces, the bottom surfaces, the inner surfaces, and the circumferences 212s and 222s of the integrated first and second resonant coil units 210 and 220.

Likewise, the hollow parts of the third and fourth injection-molded fixtures 212 and 222 are substantially the same as the hollow parts 210a and 220a of the integrated first and second resonant coil units 210 and 220.

Additionally, the insulated wire W1 forming the first resonant inductor coil 211 is an insulated coated wire, and the first resonant inductor coil 211 is a winding-type insulated coated coil. Likewise, the insulated wire W2 forming the second resonant inductor coil 221 is an insulated coated wire, and the second resonant inductor coil 221 is a winding-type insulated coated coil.

Furthermore, the first resonant inductor coil 211 is a winding-type insulated coated coil having a conductive wire W1a covered with an insulating tape W1b, and the second resonant inductor coil 221 is a winding-type insulated coated coil having a conductive wire W2a covered with an insulating tape W2b.

The insulating tapes W1b and W2b may be, for example, Kapton tapes.

Moreover, in the injection-molded fixture-integrated transformer module 1 according to an embodiment of the present invention, the first and second resonant inductor coils 211 and 221 include adhesive-type insulated coated wires W1 and W2, which have bonding layers W1c and W2c formed by covering conductive wires W1a and W2a with insulating tapes W1b and W2b and coating the outer circumferential surfaces of the covered insulating tapes W1b and W2b with an adhesive. After winding the adhesive-type insulated coated wires W1 and W2 around a winding member (not illustrated) multiple times to form a hollow part at the center, the bonding layers W1c and W2c are melted by solvent, such as alcohol, or melted (fused) by applying heat (or hot air), and then, are hardened so that the closely wound adhesive-type insulated coated wires W1 and W2 are bonded by fusion to form a coil shape.

Accordingly, the injection-molded fixture-integrated transformer 10 can maintain the standardized form of the coil even when high-pressure injection resin is pressed during the insert injection.

The injection-molded fixture-integrated transformer module 1 according to an embodiment of the present invention further includes: main magnetic cores 130 and 140 provided to be fit into the first injection-molded fixture-integrated coil unit 110 and the second injection-molded fixture-integrated coil unit 120 to increase the flux density generated by the current applied to the first and second winding-type insulated coils 111 and 121; a first resonant magnetic core 310 provided to be fit into the first injection-molded fixture-integrated resonant coil unit 210 to increase the flux density generated by the current applied to the first resonant inductor coil 211; and a second resonant magnetic core 320 provided to be fit into the second injection-molded fixture-integrated resonant coil unit 220 to increase the flux density generated by the current applied to the second resonant inductor coil 221. The first injection-molded fixture-integrated coil unit 110 and the second injection-molded fixture-integrated coil unit 120 are provided to be fit into insertion spaces between middle parts 132 and 142 and outer parts 133 and 143 of the main magnetic cores 130 and 140 while hollow parts 110a and 120a thereof are inserted into the middle parts 132 and 142 of the main magnetic cores 130 and 140. The first injection-molded fixture-integrated resonant coil unit 210 is provided to be fit into an insertion space between a middle part 312 and an outer part 313 of the first resonant magnetic core 310 while the hollow part 210a thereof is fit into the middle part 312 of the first resonant magnetic core 310. The second injection-molded fixture-integrated resonant coil unit 220 is provided to be fit into an insertion space between a middle part 322 and an outer part 313 of the second resonant magnetic core 320 while the hollow part 210a is fit into the middle part 312 of the first resonant magnetic core 310. The top surface (inner side) of the first resonant magnetic core 310 is in close contact with the bottom surface (outer side) of the main magnetic core 130, and the bottom surface (inner side) of the second resonant magnetic core 320 is in close contact with the top surface of the main magnetic core 140.

Electromagnetic waves exhibit reflection characteristics at the zero crossing point, but according to the configuration of the resonant first and second magnetic cores 310 and 320, the injection-molded fixture-integrated transformer module 1 according to an embodiment of the present invention can control the phenomena.

Furthermore, the injection-molded fixture-integrated transformer module 1 according to an embodiment of the present invention can improve the heat dissipation efficiency of the transformer by dissipating heat generated by the transformer while maintaining the characteristics of the transformer and the resonant inductors.

Additionally, as described above, since the first and second winding-type insulated coils 111 and 121 and the first and second resonant inductor coils 211 and 221 are all shielded by the magnetic cores 130, 140, 310, and 320, the efficiency and temperature characteristics resulting from ideal resonance are excellent.

The first resonant magnetic core 310 includes: a flat outer body part 311; a middle part 312 which protrudes from the center of the outer body part 311 toward the transformer and is inserted into the hollow part 210a of the first injection-molded fixture-integrated resonant coil unit 210; an outer part 313 which is spaced apart from the middle part 312 to form an insertion space, and protrudes from the outer body part 311 toward the transformer; and a flat inner body part 314 which forms a magnetic circuit with the middle part 312 and the outer part 313.

The second resonant magnetic core 320 includes: a flat outer body part 321; a middle part 322 which protrudes from the center of the outer body part 321 toward the transformer and is inserted into the hollow part 220a of the second injection-molded fixture-integrated resonant coil unit 220; an outer part 323 which is spaced apart from the middle part 322 to form an insertion space, and protrudes from the outer body part 321 toward the transformer; and a flat inner body part 324 which forms a magnetic circuit with the middle part 322 and the outer part 323.

The inner body part 314 of the first resonant magnetic core 310 is in close contact with the bottom surface of the main magnetic core 130, and the inner body part 324 of the second resonant magnetic core 320 is in close contact with the top surface of the main magnetic core 140.

The main magnetic cores 130 and 140 include a first main magnetic core 130 and a second main magnetic core 140. The first main magnetic core 130 includes: a flat lower body part 131; a middle part 132 which protrudes inward from the center of the lower body part 131 and is inserted into the hollow part 110a of the first injection-molded fixture-integrated coil unit 110; and an outer part 133 which is spaced from the middle part 132 to form an insertion space, and protrudes inward from the lower body part 131. The second main magnetic core 140 forms a magnetic circuit with the first main magnetic core 130, and includes: a flat upper body part 141; a middle part 142 which protrudes inward from the center of the upper body part 141, is inserted into the hollow part 120a of the second injection-molded fixture-integrated coil unit 120, and is in contact with the middle part 132 of the first main magnetic core 130; and an outer part 143 which is spaced from the middle part 142 to form an insertion space, protrudes inward from the upper body part 141, and is in contact with the outer part 133 of the first main magnetic core 130.

On the bottom surface 110b of the first injection-molded fixture of the first injection-molded fixture-integrated coil unit 110, a pair of lower guide protrusions 115 are formed to be placed on the first main magnetic core 130 without any movement by protruding outward (downward in the drawings), with the lower body part 131 of the first main magnetic core 130 sandwiched between them.

On the top surface 122t of the second injection-molded fixture-integrated coil unit 120, a pair of upper guide protrusions 125 are formed to be placed on the second main magnetic core 140 without any movement by protruding outward (upward in the drawings), with the upper body part 141 of the second main magnetic core 140 sandwiched between them.

When the first injection-molded fixture-integrated coil unit 110 is inserted and placed into the first main magnetic core 130 and the second injection-molded fixture-integrated coil unit 120 is inserted and placed into the second main magnetic core 140, the first top surface 112t and the second bottom surface 122b come into close contact with each other.

In the injection-molded fixture-integrated transformer module 1 according to an embodiment of the present invention, on the third bottom surface 212b of the first injection-molded fixture-integrated resonant coil unit 210, a pair of outer guide protrusions 215 are formed to be placed on the first resonant magnetic coil 310 without any movement by protruding outward (downward in the drawings), with the outer body part 311 of the first resonant magnetic core 310 sandwiched between them. On the third top surface 212t, a pair of inner guide protrusions 216 are formed to be placed on the inner body part 314 of the first resonant magnetic coil 310 without any movement by protruding inward, with the inner body part 314 of the first resonant magnetic core 310 sandwiched between them.

Likewise, on the fourth top surface 222t of the second injection-molded fixture-integrated resonant coil unit 220, a pair of outer guide protrusions 225 are formed to be placed on the second resonant magnetic coil 320 without any movement by protruding outward (downward in the drawings), with the outer body part 321 of the second resonant magnetic core 320 sandwiched between them. On the fourth bottom surface 222b, a pair of inner guide protrusions 226 are formed to be placed on the inner body part 324 of the second resonant magnetic coil 320 without any movement by protruding inward, with the inner body part 324 of the second resonant magnetic core 320 sandwiched between them.

The lower body part 131 of the first main magnetic core 130 and the inner body part 314 of the first resonant magnetic core 310 are in contact with each other. The upper body part 144 of the second main magnetic core 140 and the inner body part 324 of the second resonant magnetic core 320 are in contact with each other.

Additionally, in one embodiment, an air gap is formed between the middle part 312 and the inner body part 314. For ideal resonance, the air gap is formed in the resonant inductor.

The resonant magnetic cores 310 and 320 are RM-type cores.

The air gap is, for example, between 0.9 and 1.3 mm.

The main magnetic cores 130 and 140 are, for example, E-E type cores, and the resonant magnetic cores 310 and 320 are, for example, E-I type cores.

The air gap is formed between the middle parts of the main magnetic cores 130 and 140.

In the resonant inductor-integrated transformer module 1 according to an embodiment of the present invention, the transformer 10 is a transformer for the OBC of an electric vehicle.

In the injection-molded fixture-integrated transformer 10 and the transformer module 1 according to an embodiment of the present invention, the winding member can be a winding jig or a winding machine.

The adhesive may be an adhesive paint.

The insulating tapes W1b and W2b may be, for example, Kapton tapes.

Meanwhile, the conductive wires W1a and W2a covered with the insulating tapes W1b and W2b may include any known conductive materials.

For example, the conductive wires W1a and W2a of the first and second resonant inductor coils 211 and 221 may be made of winding-type copper wire, may be composed of copper stranded wire formed by twisting multiple strands of copper wire Li, or may be formed by insulated-coating the winding-type copper wire or the copper stranded wire, and any of the variations fall within the technical scope of the present invention.

As described above, the preferred embodiments of the present invention have been described, and it is apparent to those skilled in the art that the present invention may be embodied in other specific forms without departing from the technical idea or essential features of the present invention. Therefore, the embodiments should be understood as illustrative rather than restrictive.

The scope of the present invention is defined by the appended claims, rather than the above description, and ail changes or modifications derived from the meaning, scope and equivalents of the appended claims should be interpreted as falling within the scope of the present invention.

What is claimed is:

1. An injection-molded fixture-integrated transformer comprising:
a first injection-molded fixture-integrated coil unit, which includes: a first winding-type insulated coil, on which a flexible insulated wire is wound multiple times around a first hollow part, which is formed at the center thereof for the insertion of middle parts of magnetic cores, with the turns in close contact with each other; and a first injection-molded fixture, which wraps the first winding-type insulated coil by synthetic resin injection-molding, is formed integrally with the first winding-type insulated coil, and electrically insulates the first winding-type insulated coil from the outside to maintain the fixed form of the insulated wire which is wound multiple times and forms the first winding-type insulated coil; and
a second injection-molded fixture-integrated coil unit, which includes: a second winding-type insulated coil, which generates induced current from the current applied to the first winding-type insulated coil, and on which a flexible insulated wire is wound multiple times around a second hollow part, which is formed at the center thereof for the insertion of the middle parts of the magnetic cores, with the turns in close contact with each other; and a second injection-molded fixture, which wraps the second winding-type insulated coil by synthetic resin injection-molding, is formed integrally with the second winding-type insulated coil and electrically insulates the second winding-type insulated coil from the outside to maintain the fixed form of the insulated wire which is wound multiple times and forms the second winding-type insulated coil.

2. The injection-molded fixture-integrated transformer according to claim 1, wherein the first injection-molded fixture is formed along the first winding-type insulated coil to partially enclose the first winding-type insulated coil, which is in the shape of a ring,
wherein the first injection-molded fixture has a plurality of first exposure parts formed to expose the first winding-type insulated coil,
wherein the second injection-molded fixture is formed along the second winding-type insulated coil to partially enclose the second winding-type insulated coil, which is in the shape of a ring, and
wherein the second injection-molded fixture has a plurality of second exposure parts formed to expose the second winding-type insulated coil.

3. The injection-molded fixture-integrated transformer according to claim 2, wherein the first injection-molded fixture which partially encloses the first winding-type insulated coil includes a first flat top surface, a first flat bottom surface, a first inner surface with a hollow part, and a first circumference which is the exterior surface, and the plurality of first exposure parts are formed along the first inner surface and the first outer circumference, and
wherein the second injection-molded fixture which partially encloses the second winding-type insulated coil includes a second flat top surface, a second flat bottom surface, a second inner surface with a hollow part, and a second circumference which is the exterior surface, and the plurality of second exposure parts are formed along the second inner surface and the second outer circumference.

4. The injection-molded fixture-integrated transformer according to claim 1, wherein in a state where the first winding-type insulated coil is inserted into a cavity of the injection mold in such a manner that a wire inlet side and a wire outlet side are exposed, a molding resin is injected into the cavity of the injection mold under high pressure to form the first injection-molded fixture and integrally bond the first injection-molded fixture with the first winding-type insulated coil,
wherein injection resin fills between the turns of the first winding-type insulated coil to form the first injection-molded fixture,
wherein in a state where the second winding-type insulated coil is inserted into a cavity of the injection mold in such a manner that a wire inlet side and a wire outlet side are exposed, a molding resin is injected under high pressure into the cavity of the injection mold to form the second injection-molded fixture and integrally bond the second injection-molded fixture with the second winding-type insulated coil, and
wherein injection resin fills between the turns of the second winding-type insulated coil to form the second injection-molded fixture.

5. The injection-molded fixture-integrated transformer according to claim 1, wherein the first winding-type insulated coil is a winding-type insulated coated coil having a conductive wire covered with insulating tape, and
wherein the second winding-type insulated coil is a winding-type insulated coated coil having a conductive wire covered with insulating tape.

6. The injection-molded fixture-integrated transformer according to claim 1, wherein the first and second winding-type insulated coils include adhesive-type insulated coated wires, which have bonding layers formed by covering conductive wires with insulating tapes and coating the outer circumferential surfaces of the covered insulating tapes with an adhesive, and
wherein after winding the adhesive-type insulated coated wires around a winding member multiple times to form a hollow part at the center, the coated bonding layers are melted and hardened so that the closely wound adhesive-type insulated coated wires are bonded by fusion to form a coil shape.

7. An injection-molded fixture-integrated transformer module comprising:
an injection-molded fixture-integrated transformer as described in claim 1;
a first injection-molded fixture-integrated resonant coil unit including: a first resonant inductor coil, which is directly connected to the first winding-type insulated coil to perform the resonant interaction with the inherent capacitance of the injection-molded fixture-integrated transformer, and on which a flexible insulated wire is wound multiple times around a third hollow part, which is formed at the center thereof for the insertion of a middle part of a magnetic core, with the turns in close contact with each other; and a third injection-molded fixture, which wraps the first resonant inductor coil by synthetic resin injection-molding, is formed integrally with the first resonant inductor coil, and electrically insulates the first resonant inductor coil from the outside to maintain the overall specific form of the insulated wire which is wound multiple times and forms the first winding-type insulated coil; and
a second injection-molded fixture-integrated resonant coil unit including: a second resonant inductor coil, which is directly connected to the second winding-type insulated coil to perform the resonant interaction with the inherent capacitance of the injection-molded fixture-integrated transformer, and on which a flexible insulated wire is wound multiple times around a fourth hollow part, which is formed at the center thereof for the insertion of a middle part of a magnetic core, with the turns in close contact with each other; and a fourth injection-molded fixture, which wraps the second resonant inductor coil by synthetic resin injection-molding, is formed integrally with the second resonant inductor coil, and electrically insulates the second resonant inductor coil from the outside to maintain the overall specific form of the insulated wire which is wound multiple times and forms the second resonant inductor coil.

8. The injection-molded fixture-integrated transformer module according to claim 7, wherein the first winding-type insulated coil and the first resonant inductor coil are formed by a single insulated wire,
wherein the first winding-type insulated coil is inserted into a cavity of an injection mold in a state where a wire inlet side and a wire outlet side of the first winding-type insulated coil are exposed,
wherein the first resonant inductor coil is inserted into a cavity of an injection mold in a state where a wire inlet side and a wire outlet side of the first resonant inductor coil are exposed,
wherein when resin for forming the first and third injection-molded fixtures is injected into the cavities of the injection mold under high pressure, the first injection-molded fixture is formed, and at the same time, the first winding-type insulated coil is integrally bonded with the first injection-molded fixture, and the third injection-molded fixture is formed, and at the same time, the first resonant inductor coil is integrally bonded with the third injection-molded fixture,
wherein the injection resin fills the spaces between the turns of the first winding-type insulated coil for forming the first injection-molded fixture, and fills the spaces between the turns of the first resonant inductor coil for forming the third injection-molded fixture,
wherein the second winding-type insulated coil and the second resonant inductor coil are formed by a single insulated wire,
wherein the second winding-type insulated coil is inserted into a cavity of an injection mold in a state where a wire inlet side and a wire outlet side of the second winding-type insulated coil are exposed,
wherein the second resonant inductor coil is inserted into a cavity of an injection mold in a state where a wire inlet side and a wire outlet side of the second resonant inductor coil are exposed,
wherein when resin for forming the second and fourth injection-molded fixtures is injected into the cavities of the injection mold under high pressure, the second injection-molded fixture is formed, and at the same time, the second winding-type insulated coil is integrally bonded with the second injection-molded fixture, and the fourth injection-molded fixture is formed, and at the same time, the second resonant inductor coil is integrally bonded with the fourth injection-molded fixture, and
wherein the injection resin fills the spaces between the turns of the second winding-type insulated coil for forming the second injection-molded fixture, and fills the spaces between the turns of the second resonant inductor coil for forming the fourth injection-molded fixture.

9. The injection-molded fixture-integrated transformer module according to claim 7, wherein the third injection-molded fixture is formed along the first resonant inductor coil with a ring shape to partially enclose the first resonant inductor coil, and includes a plurality of third exposure parts for exposing the first resonant inductor coil, and
wherein the fourth injection-molded fixture is formed along the second resonant inductor coil with a ring shape to partially enclose the second resonant inductor coil, and includes a plurality of fourth exposure parts for exposing the second resonant inductor coil.

10. The injection-molded fixture-integrated transformer module according to claim 7, further comprising:
main magnetic cores provided to be fit into the first injection-molded fixture-integrated coil unit and the second injection-molded fixture-integrated coil unit to increase the flux density generated by the current applied to the first and second winding-type insulated coils;
a first resonant magnetic core provided to be fit into the first injection-molded fixture-integrated resonant coil unit to increase the flux density generated by the current applied to the first resonant inductor coil; and
a second resonant magnetic core provided to be fit into the second injection-molded fixture-integrated resonant coil unit to increase the flux density generated by the current applied to the second resonant inductor coil,
wherein the first injection-molded fixture-integrated coil unit and the second injection-molded fixture-integrated coil unit are provided to be fit into insertion spaces between middle parts and outer parts of the main magnetic cores while hollow parts thereof are inserted into the middle parts of the main magnetic cores,
wherein the first injection-molded fixture-integrated resonant coil unit is provided to be fit into an insertion space between a middle part and an outer part of the first resonant magnetic core while the hollow part thereof is fit into the middle part of the first resonant magnetic core,
wherein the second injection-molded fixture-integrated resonant coil unit is provided to be fit into an insertion space between a middle part and an outer part of the second resonant magnetic core while the hollow part is fit into the middle part of the first resonant magnetic core,
wherein the top surface of the first resonant magnetic core is in close contact with the bottom surface of the main magnetic core, and
wherein the bottom surface of the second resonant magnetic core is in close contact with the top surface of the main magnetic core.
